(19) United States
(12) Patent Application Publication
(10) Pub. No.: US 2024/0028764 A1
(43) Pub. Date: Jan. 25, 2024

(54) KNOWLEDGE GRAPH ACCESS CONTROL SYSTEM

(71) Applicant: Hitachi, Ltd., Tokyo (JP)

(72) Inventors: Kunihiko HARADA, Tokyo (JP); Shigenori MATSUMOTO, Tokyo (JP); Hiromitsu NAKAGAWA, Tokyo (JP)

(21) Appl. No.: 18/118,340

(22) Filed: Mar. 7, 2023

(30) Foreign Application Priority Data
Jul. 19, 2022 (JP) 2022-114575

(51) Int. Cl. G06F 21/62

(52) U.S. Cl. CPC G06F 21/6254; G06F 2221/2113

(57) ABSTRACT

A knowledge graph access control system includes an arithmetic device and a storage device. The storage device stores obfuscation structure information that defines an inclusion relationship between elements with different degrees of obfuscation in a knowledge graph, and access control information for managing user's access rights to each element included in the obfuscation structure information. The arithmetic device is configured to acquire an obfuscation target knowledge graph, generate an obfuscation knowledge graph by obfuscating the target knowledge graph for a first user with reference to the obfuscation structure information and the access control information, and in the obfuscation of the target knowledge graph, convert an original element included in the target knowledge graph to an obfuscation element to which the first user has access rights in the access control information, and which includes the original element in the obfuscation structure information.

### CLAIM OF PRIORITY

The present application claims priority from Japanese patent application JP2022-114575 filed on Jul. 19, 2022, the content of which is hereby incorporated by reference into this application.

### BACKGROUND

The present invention relates to controlling access to knowledge graphs.

A knowledge graph is a graph structure in which various types of knowledge are systematically connected. A graph structure is represented by a set of nodes and a set of arcs, and an arc is represented by a start node and an end node. Knowledge graphs often have information associated with nodes and arcs.

In recent years, digital transformation has accelerated in various industries, and it is required to deal with rapid business changes. Therefore, it is useful to organize customer projects systematically and use it to obtain suggestions for other customer projects. For example, this corresponds to organizing the flow of funds and information among stakeholders in each business, and organizing the relationship between customer management issues and individual technology application issues. Such information is organized as a knowledge graph.

For example, JP2021-513138A stores a knowledge graph as a hierarchical (tree) structure of sub-graphs, manages access rights to respective sub-graphs, and displays an appropriate knowledge graph to users. JP2021-513138A manages the sub-graph structure of the knowledge graph as a hierarchical structure, and controls disclosure and non-disclosure of each node (sub-graph).

### SUMMARY

When dealing with individual projects, the disclosure of sensitive information becomes a bottleneck, and the utilization of knowledge graphs between different organizations is not progressing. Therefore, when utilizing a knowledge graph that includes sensitive project information, access control of information granularity is required. However, it takes a lot of time and cost to redefine the knowledge graph to the level that can be disclosed by a human from scratch. The cost of managing knowledge graphs with different disclosure levels is also high.

One aspect of the present invention has been made in view of such circumstances, and an object of the present invention is to provide an efficient access control technique for knowledge graphs, which can promote the utilization of knowledge graphs.

An aspect of the present invention is a knowledge graph access control system including: an arithmetic device; and a storage device. The storage device stores: obfuscation structure information that defines an inclusion relationship between elements with different degrees of obfuscation in a knowledge graph; and access control information for managing user's access rights to each element included in the obfuscation structure information. The arithmetic device is configured to: acquire an obfuscation target knowledge graph; generate an obfuscation knowledge graph by obfuscating the target knowledge graph for a first user with reference to the obfuscation structure information and the access control information; and in the obfuscation of the target knowledge graph, convert an original element included in the target knowledge graph to an obfuscation element to which the first user has access rights in the access control information, and which includes the original element in the obfuscation structure information.

According to one aspect of the present invention, it is possible to promote utilization of knowledge graphs by efficient access control to knowledge graphs. Other problems, configurations, and effects other than those described above will become apparent by the following description of the embodiments.

### BRIEF DESCRIPTION OF THE DRAWINGS

FIG. 1 is a diagram showing a configuration example of a computer according to an embodiment of the present specification.

FIG. 2 shows an example of knowledge graph.

FIG. 3A shows a configuration example of personal management information.

FIG. 3B shows a configuration example of team management information.

FIG. 3C shows a configuration example of personal and team relationship information.

FIG. 4A shows a configuration example of graph management information.

FIG. 4B shows a configuration example of node information.

FIG. 4C shows a configuration example of arc information.

FIG. 4D shows a configuration example of graph and node relationship information.

FIG. 4E shows a configuration example of graph and arc relationship information.

FIG. 5 schematically shows an example of a node obfuscation structure 400 indicated by the node obfuscation structure information.

FIG. 6A shows a configuration example of node information in the node obfuscation structure.

FIG. 6B shows arc information in the node obfuscation structure.

FIG. 7 schematically shows an example of an arc obfuscation structure indicated by the arc obfuscation structure information.

FIG. 8A shows a configuration example of node information in an arc obfuscation structure.

FIG. 8B shows arc information in the arc obfuscation structure.

FIG. 9A shows a configuration example of node access management information included in the access control information.

FIG. 9B shows a configuration example of the arc access management information included in the access control information.

FIG. 10 shows a flowchart of an example of an algorithm for generating an obfuscation knowledge graph.

FIG. 11 shows an example of a graphical user interface screen for knowledge graph obfuscation.

FIG. 12 shows a configuration example of a computer of an embodiment of the present specification.

FIG. 13 shows a flowchart of an example of an information granularity evaluation algorithm executed by the information granularity evaluation unit.

FIG. 14A is a diagram for explaining an example of the set s[n].

FIG. 14B is a diagram for explaining the number of unique teams that have access rights to a target node.

FIG. 14C is a diagram for explaining the number of unique teams that have access rights to nodes on the path between the target node and the original obfuscation source node.

FIG. 15 shows a configuration example of the computer 100 of an embodiment of the present specification.

FIG. 16 shows a flowchart of an example of an obfuscation DAG arc recommendation algorithm executed by the obfuscation information recommendation unit.

FIG. 17 shows a configuration example of a computer according to an embodiment of the present specification.

FIG. 18 shows a flowchart of an example of an obfuscation DAG node access right recommendation algorithm executed by the access control information recommendation unit.

FIG. 19 shows a flowchart of an example of an automatic obfuscated knowledge graph generation and access rights recommendation algorithm.

FIG. 20 shows an example of GUI screen for prediction of access rights to the knowledge graph described with reference to FIG. 19.

FIG. 21 shows an example of GUI screen for prediction of access rights to the knowledge graph described with reference to FIG. 19.

### EMBODIMENTS

Hereinafter, embodiments of the present invention will be described with reference to the drawings. However, the present invention should not be construed as being limited to the contents of the embodiments described below. Those skilled in the art will easily understand that the specific configuration can be changed without departing from the idea or gist of the present invention.

In the configuration of the invention described below, the same or similar components or functions are denoted by the same reference numerals, and redundant description may be omitted. The notations such as “first”, “second”, “third”, or the like in this specification and the like are attached to identify the components, and do not necessarily limit the number or order of the components.

A system of an embodiment of the present specification may be a physical computer system (one or more physical computers), or may be a system built on a computing resource group (a plurality of computing resources) such as a cloud platform. A computer system or a computing resource group includes one or more interface devices (for example, including communication devices and input/output devices), one or more storage devices (for example, including memory (main storage) and auxiliary storage devices), and one or more arithmetic devices.

When a function is realized by an arithmetic device executing a program including command codes, since the designated processing is performed while appropriately using a storage device and/or an interface device, and the like, the function may be at least a part of the arithmetic device. Processing described with a function as a subject may be processing performed by an arithmetic device or a system having the arithmetic device. Programs may be installed from program sources.

The program source may be, for example, a program distribution computer or a computer-readable storage medium (for example, a computer-readable non-transitory storage medium). The description of each function is an example, and a plurality of functions may be combined into one function, or one function may be divided into a plurality of functions.

The position, size, shape, range, and the like of each component shown in the drawings may not represent the actual position, size, shape, range, and the like in order to facilitate understanding of the invention. Therefore, the present invention is not limited to the position, size, shape, range, and the like disclosed in the drawings and the like.

An embodiment of the present specification manages knowledge graph elements based on information granularity, and discloses only information of a level suitable for the user based on information of that information granularity. In addition, a system of an embodiment of the present specification provides support functions such as recommendation of obfuscation candidates for elements and prediction of access rights. An embodiment of the present specification enables a knowledge graph to be displayed with appropriate information granularity depending on the user. As a result, the results of analyzing individual projects as knowledge graphs can be shared with those who cannot see even sensitive information, and the range of utilization of accumulated knowledge can be expanded.

Information with higher granularity is more obscure information. That is, the higher the granularity, the higher the degree of obfuscation. Changing information with lower granularity to information with higher granularity is called obfuscation. In other words, an embodiment of the present specification obfuscates descriptions of knowledge graph elements, that is, nodes and connecting arcs between nodes, in access control to the knowledge graph. The obfuscated description is a semantically broader description that encompasses the description before it was obfuscated.

A system of an embodiment of the present specification manages the obfuscation of knowledge graph elements using a directed acyclic graph (DAG). In this way, it is possible to more appropriately and efficiently manage the obfuscation structure of knowledge graph elements. The obfuscation structure defines the inclusion relationship between elements. The obfuscation structure may be managed by other formats.

### First Embodiment

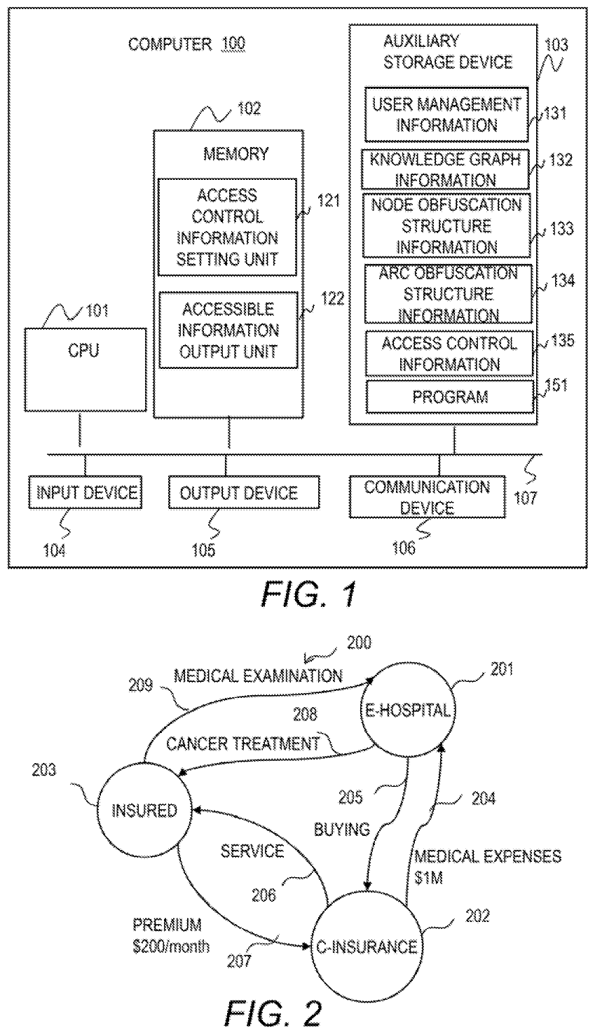

FIG. 1 is a diagram showing a configuration example of a computer according to an embodiment of the present specification. A computer 100 is, for example, a personal computer, a server, or a workstation, and includes a central processing unit (CPU) 101, a memory 102, an auxiliary storage device 103, an input device 104, an output device 105, and a communication device 106. The hardware elements are connected to each other via a bus 107.

The CPU 101 is an arithmetic device that executes programs stored in the memory 102. The CPU 101 operates as a functional unit (module) that implements a specific function by executing processing according to a program. In the following description, when processing is described with a functional unit as the subject, it means that the CPU 101 is executing a program that implements the functional unit.

The memory 102 is a storage device such as a dynamic random access memory (DRAM), and stores programs executed by the CPU 101 and information used by the CPU 101. The memory 102 also includes a work area that is temporarily used by the CPU 101. The programs stored in memory 102 will be described later.

Note that the programs and information stored in the memory 102 may be stored in the auxiliary storage device 103. In this case, the CPU 101 reads programs and information from the auxiliary storage device 103, loads them into the memory 102, and executes the programs stored in the memory 102.

The auxiliary storage device 103 is a storage device such as a hard disk drive (HDD) and a solid state drive (SSD), and permanently stores data. Information stored in the auxiliary storage device 103 will be described later. The auxiliary storage device 103 may be a drive device for storage media such as a compact disc recordable (CD-R), a digital versatile disk-random access memory (DVD-RAM), a silicon disk, or the like. In this case, information and programs are stored on storage media.

The input device 104 is, for example, a keyboard, a mouse, a scanner, a microphone, or the like, and is a device for inputting data to the computer 100. The output device 105 is a display, a printer, a speaker, or the like, and is a device for outputting data from the computer 100 to the outside. The communication device 106 is, for example, a device for communicating via a network such as a local area network (LAN).

Note that some of the components shown in FIG. 1, for example, the input device 104, the output device 105, and/or the communication device 106, may be omitted from the computer 100. The computer 100 may be connected to another terminal via a network to receive user input from the terminal via the input device of the terminal, and may transmit processing results to the terminal and the output device 105 of the terminal may present the processing results to the user.

The information stored in the auxiliary storage device 103 and the programs stored in the memory 102 will be described. The auxiliary storage device 103 stores user management information 131, knowledge graph information 132, node obfuscation structure information 133, arc obfuscation structure information 134, access control information 135 and all types of programs 151.

The user management information 131 manages personal users and teams to which the users belong. The knowledge graph information 132 includes a plurality of knowledge graphs. In the example described below, the knowledge graph information 132 includes a project-based knowledge graph.

The node obfuscation structure information 133 is information referred to in order to obfuscate nodes in the knowledge graph information 132. In the example described later, the node obfuscation structure information 133 has a DAG structure. The arc obfuscation structure information 134 is information referred to in order to obfuscate arcs in the knowledge graph information 132. In the example described later, the arc obfuscation structure information 134 has a DAG structure.

The access control information 135 is information referred to in order to control the user's access to the knowledge graph elements. The programs 151 include various programs that are loaded into the memory 102 and executed by the CPU 101.

The memory 102 stores programs that implement the access control information setting unit 121 and the accessible information output unit 122. These programs are included in the programs 151 and loaded into the memory 102 for execution by the CPU 101. As for the functional units of the computer 100, a plurality of functional units may be combined into one functional unit, or one functional unit may be divided into a plurality of functional units for each function.

Further, the present embodiment may be implemented as a computer system in which the functional units of the computer 100 are distributed to a plurality of computers. For example, a computer system including a computer having the access control information setting unit 121, a computer having the accessible information output unit 122, and a storage system for storing each piece of information can be considered.

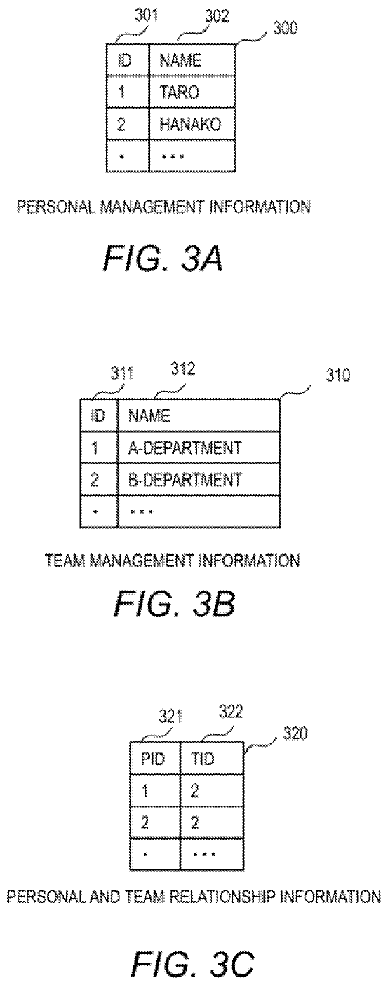

The contents of the information stored in the auxiliary storage device 103 will be described below. For ease of explanation, the example of the knowledge graph shown in FIG. 2 will be used. The information described below includes information of the knowledge graph 200 shown in FIG. 2. The knowledge graph 200 includes an E-hospital node 201, a C-insurance node 202 and an insured node 203. “E-Hospital”, “C-Insurance” and “Insured” are descriptions of these nodes.

The knowledge graph 200 further includes arcs 204 to 209. Each arc goes from a source node to a target node. Each arc is given a description, which is shown next to each arc in FIG. 2. For example, the description of the arc 208 from the E-hospital node 201 to the insured node 203 is “cancer treatment”, and the description of the arc 209 from the insured node 203 to the E-hospital node 201 is “medical examination”. Note that there may be arcs in only one direction between nodes, or there may be no description for arcs.

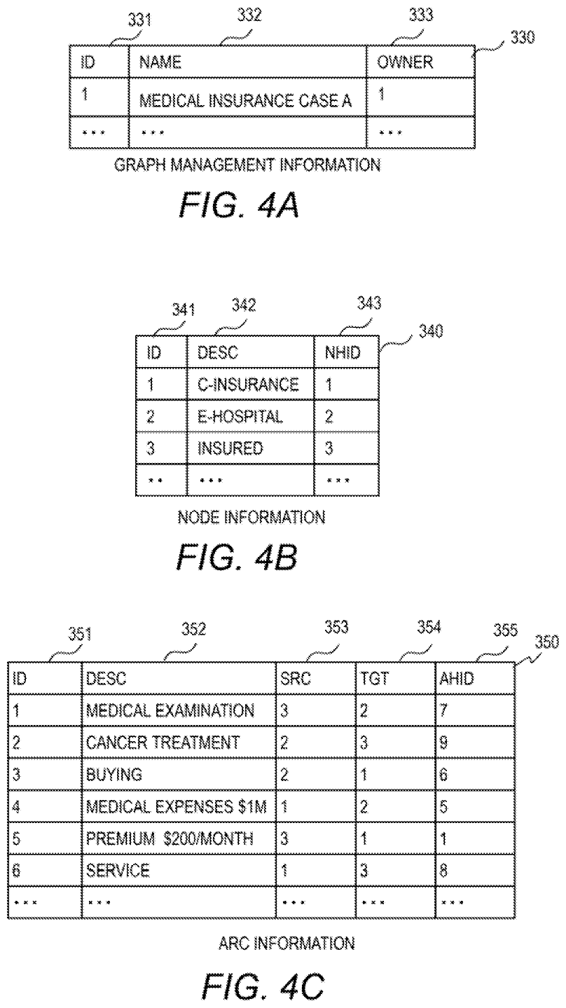

FIGS. 3A to 3C show configuration examples of information included in the user management information 131. FIG. 3A shows a configuration example of personal management information 300. The personal management information 300 includes a record ID column 301 and a personal name column 302 of users who can use the system. FIG. 3B shows a configuration example of team management information 310. Each user belongs to one of the teams. The team management information 310 includes a record ID column 311 and a team name column 312.

FIG. 3C shows a configuration example of personal and team relationship information 320. The personal and team relationship information 320 indicates personal users who belong to each team. Personal and team relationship information 320 includes a personal ID (PID) column 321 and a team ID (TID) column 322. The ID in the PID column 321 matches the ID in the record ID column 301 of the personal management information 300. The ID in the TID column 322 matches the ID in the record ID column 311 of the team management information 310.

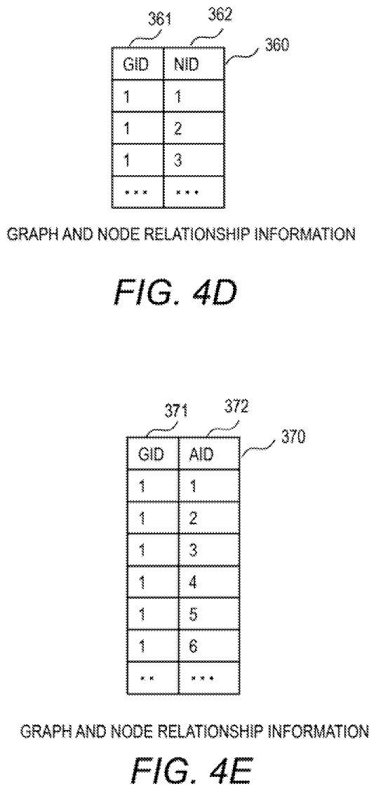

FIGS. 4A to 4E show configuration examples of information included in the knowledge graph information 132. FIG. 4A shows a configuration example of graph management information 330. The graph management information 330 manages knowledge graphs included in the knowledge graph information 132. The graph management information 330 includes a record ID column 331, a knowledge graph name column 332, and a knowledge graph owner column 333.

FIG. 4B shows a configuration example of node information 340. The node information 340 is information about nodes of all knowledge graphs managed by the graph management information 330. The node information 340 includes a record ID column 341, a description (DESC) column 342 and a node hierarchy ID column (NHID) 343. The record ID column 341 indicates IDs of nodes in all knowledge graphs. The description column 342 indicates the description given to each node. The node hierarchy ID column 343 indicates the node ID in the node obfuscation structure described below.

FIG. 4C shows a configuration example of arc information 350. The arc information 350 is information on arcs of all knowledge graphs managed by the graph management information 330. The arc information 350 includes a record ID column 351, a description column 352, a source (SRC) column 353, a target (TGT) column 354 and an arc hierarchy ID column (AHID) 355. The record ID column 351 indicates IDs of arcs in all knowledge graphs. The description column 352 indicates the description given to each arc. The source column 353 and the target column 354 indicate the source and target of the arc. The arc hierarchy ID column 355 indicates the ID of the node representing the arc in the arc obfuscation structure described below.

FIG. 4D shows a configuration example of graph and node relationship information 360. The graph and node relationship information 360 shows the graph that includes each node. The graph and node relationship information 360 includes a graph ID (GID) column 361 and a node ID (NID) column 362. The ID in the GID column 361 matches the ID in the record ID column 331 of the graph management information 330. The ID in the NID column 362 matches the ID in the record ID column 341 of the node information 340.

FIG. 4E shows a configuration example of graph and arc relationship information 370. The graph and arc relationship information 370 shows the graph that includes each arc. The graph and arc relationship information 370 includes a graph ID (GID) column 371 and an arc ID (NID) column 372. The ID in the GID column 371 matches the ID in the record ID column 331 of the graph management information 330. The ID in the NID column 372 matches the ID in the record ID column 351 of the arc information 350.

Next, the node obfuscation structure information 133 will be described. The node obfuscation structure information 133 is registered in advance by, for example, a system designer. The node obfuscation structure information 133 manages node obfuscation information in a predetermined structure. The node obfuscation information indicates a description obtained by obfuscating the description of the nodes of the knowledge graph. In an embodiment of the present specification, node obfuscation information is represented by a DAG. A DAG shows a hierarchy of descriptions that obfuscate node descriptions. A plurality of obfuscation hierarchies allows the creation of a more suitable obfuscation knowledge graph for each user.

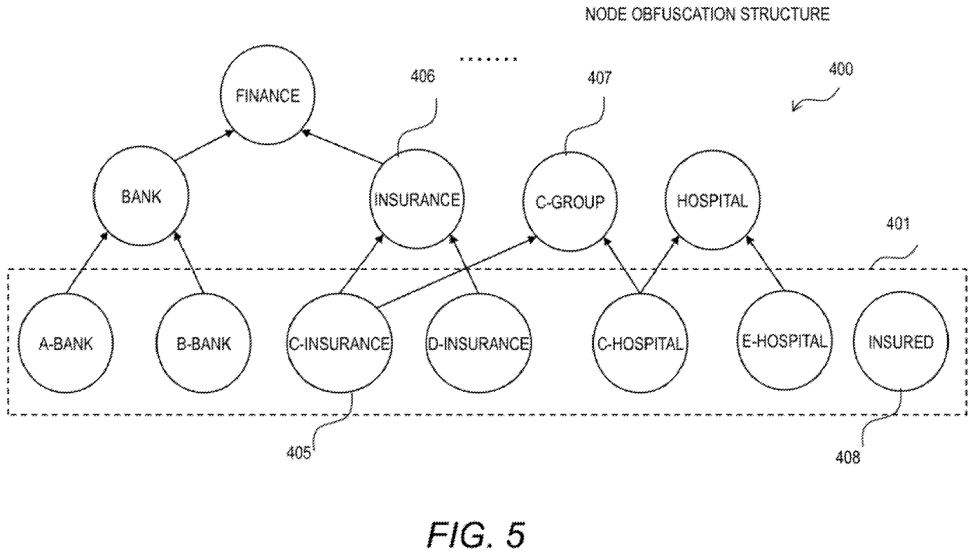

FIG. 5 schematically shows an example of a node obfuscation structure 400 indicated by the node obfuscation structure information 133. The node obfuscation structure 400 is a DAG, and a node group 401 with no input arcs indicates nodes of the non-obfuscated knowledge graph. An arc connects the source node of the obfuscation source and the target node of the obfuscation result. The output destination node of the arc indicates a node obtained by obfuscating description of the output source node. As nodes are followed by arcs, the degree of obfuscation of the nodes increases.

A node can be obfuscated in one or more ways. For example, in the node obfuscation structure 400, a C-insurance node 405 is obfuscated into an insurance node 406 and a C-group node 407. It is also possible that there is no obfuscation node for a certain node. For example, there is no node that obfuscates the insured node 408.

The description of the obfuscation node (the obfuscated description) is a higher-level description that includes the description of the source node (original description). For example, “insurance” includes “C-insurance” and “D-insurance.” Moreover, “C-group” includes “C-insurance” and “C-hospital”.

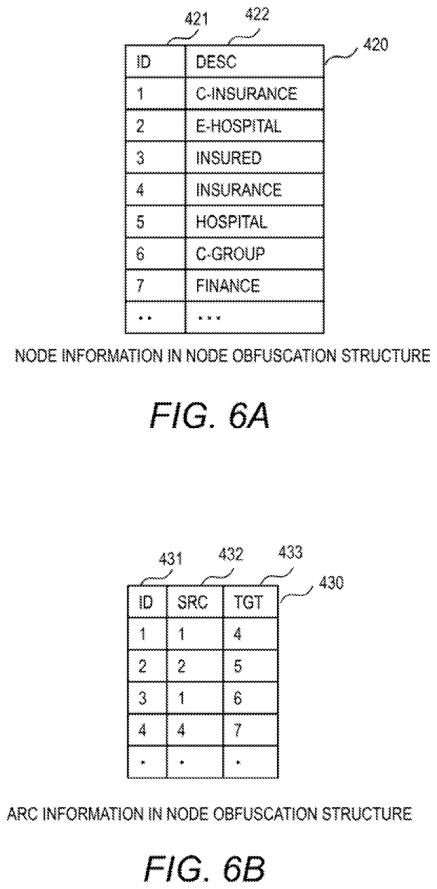

In the present embodiment, the node obfuscation structure 400 is made up of several tables. FIGS. 6A and 6B show information defining the node obfuscation structure 400. FIG. 6A shows a configuration example of node information 420 in the node obfuscation structure. The node information 420 in the node obfuscation structure includes a record ID column 421 and a description (DESC) column 422. The record ID column 421 indicates the ID of the node in the node obfuscation structure 400. The ID indicated by the node hierarchy ID column 343 of the node information 340 is included in the record ID column 421. The description column 422 shows the description given to each node.

FIG. 6B shows arc information 430 in the node obfuscation structure. The arc information 430 in the node obfuscation structure includes a record ID column 431, a source (SRC) column 432 and a target (TGT) column 433. The record ID column 431 indicates the ID of the arc in the node obfuscation structure 400. The source column 432 and the target column 433 indicate the source and target of the arc.

Next, the arc obfuscation structure information 134 will be described. The arc obfuscation structure information 134 is registered in advance by, for example, a system designer. The arc obfuscation structure information 134 manages node obfuscation information in a predetermined structure. The arc obfuscation information indicates a description obtained by obfuscating the arc description of the knowledge graph. In an embodiment of the present specification, arc obfuscation information is represented by a DAG. A DAG shows a hierarchy of descriptions that obfuscate the arc descriptions. A plurality of obfuscation hierarchies allows the creation of a more suitable obfuscation knowledge graph for each user.

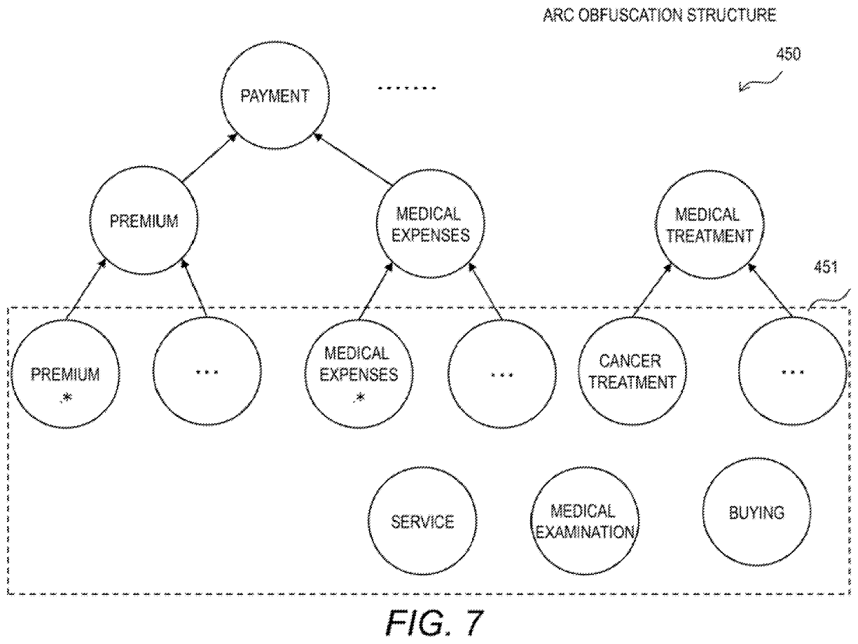

FIG. 7 schematically shows an example of an arc obfuscation structure 450 indicated by the arc obfuscation structure information 134. The arc obfuscation structure 450 is a DAG, and a node group 451 with no input arcs indicates arcs of the non-obfuscated knowledge graph. The nodes of the arc obfuscation structure 450 represent descriptions of arcs in the knowledge graph that is non-obfuscated or obfuscated.

In the arc obfuscation structure 450 of FIG. 7, an arc connects the source node of the obfuscation source and the target node of the obfuscation result. An output destination node (knowledge graph arc) of an arc is a node obtained by obfuscating description of an output source node (knowledge graph arc). As nodes are followed by arcs, the degree of obfuscation of the nodes (knowledge graph arcs) increases.

An arc in the knowledge graph, that is, a node in the arc obfuscation structure 450, can be obfuscated in one or more ways. It is also possible that there is no obfuscation arc for an arc in the knowledge graph.

An obfuscated arc description is a higher-level description that includes the original arc description. For example, “medical expenses” includes “medical expenses*”. Here, “*” means any character string. In addition, “medical treatment” includes “cancer treatment”.

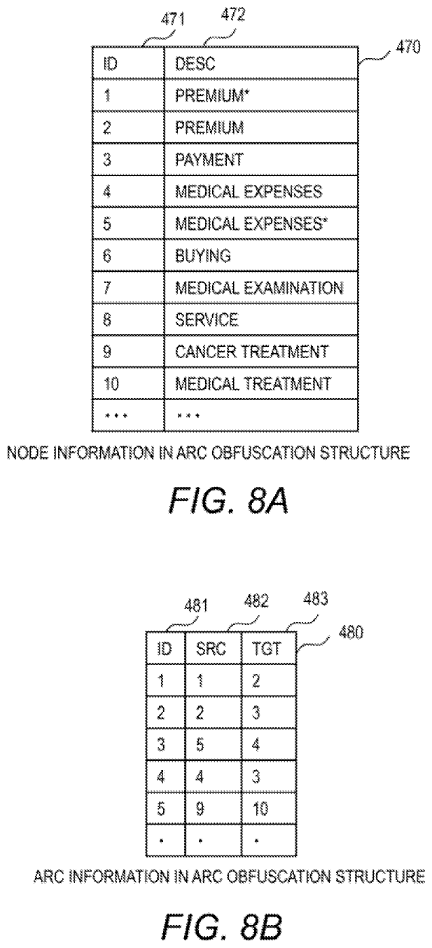

In the present embodiment, the arc obfuscation structure 450 is made up of several tables. FIGS. 8A and 8B show information defining the arc obfuscation structure 450. FIG. 8A shows a configuration example of node information 470 in an arc obfuscation structure. The node information 470 in the arc obfuscation structure includes a record ID column 471 and a description (DESC) column 472. The record ID column 471 indicates the ID of the node in the arc obfuscation structure 450. The IDs in the arc hierarchy ID column 355 of the arc information 350 are included in the record ID column 471. The description column 422 shows the description given to each node.

FIG. 8B shows arc information 480 in the arc obfuscation structure. The arc information 480 in the arc obfuscation structure includes a record ID column 481, a source (SRC) column 482, and a target (TGT) column 483. The record ID column 431 indicates the ID of the arc in the arc obfuscation structure 450. The source column 482 and the target column 483 indicate the source and target of the arc.

Next, the access control information 135 will be explained. The access control information 135 manages user's access rights to nodes and arcs of the knowledge graph. The access control information setting unit 121 generates access control information 135 according to user input, for example.

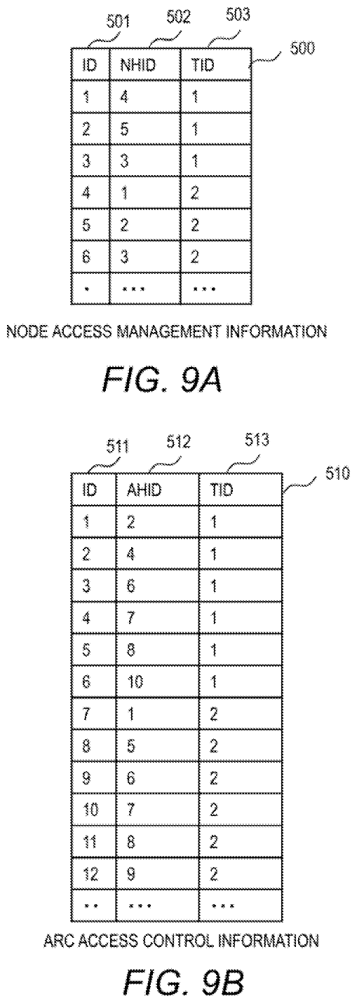

FIG. 9A shows a configuration example of node access management information 500 included in the access control information 135. In this example, the node access management information 500 manages teams that have access rights to each node in the node obfuscation structure information 133.

The node access management information 500 includes a record ID column 501, a node hierarchy ID column (NHID) 502 and a team ID (TID) column 503. The node hierarchy ID column 502 indicates the ID of the node in the node obfuscation structure information 133 and is included in the record ID column 421 of the node information 420 in the node obfuscation structure. The team ID column 503 indicates the ID of the team that has access rights to the corresponding node in the node obfuscation structure information 133.

FIG. 9B shows a configuration example of the arc access management information 510 included in the access control information 135. In this example, arc access management information 510 manages teams that have access rights to each node (indicating an arc) in the arc obfuscation structure information 134.

The arc access management information 510 includes a record ID column 511, an arc hierarchy ID column (AHID) 512 and a team ID (TID) column 513. The arc hierarchy ID column 512 indicates the ID of a node (indicating an arc) in the arc obfuscation structure information 134 and is included in the record ID column 471 of the node information 470 in the arc obfuscation structure. The team ID column 513 indicates the ID of the team that has access rights to the corresponding node (indicating the arc) in the arc obfuscation structure information 134.

Note that the node access management information 500 and the arc access management information 510 may indicate user IDs instead of team IDs. Moreover, access rights to the nodes and arcs of the obfuscation structure may be managed for each knowledge graph. In this configuration, the node access management information 500 and the arc access management information 510 further include a graph ID column.

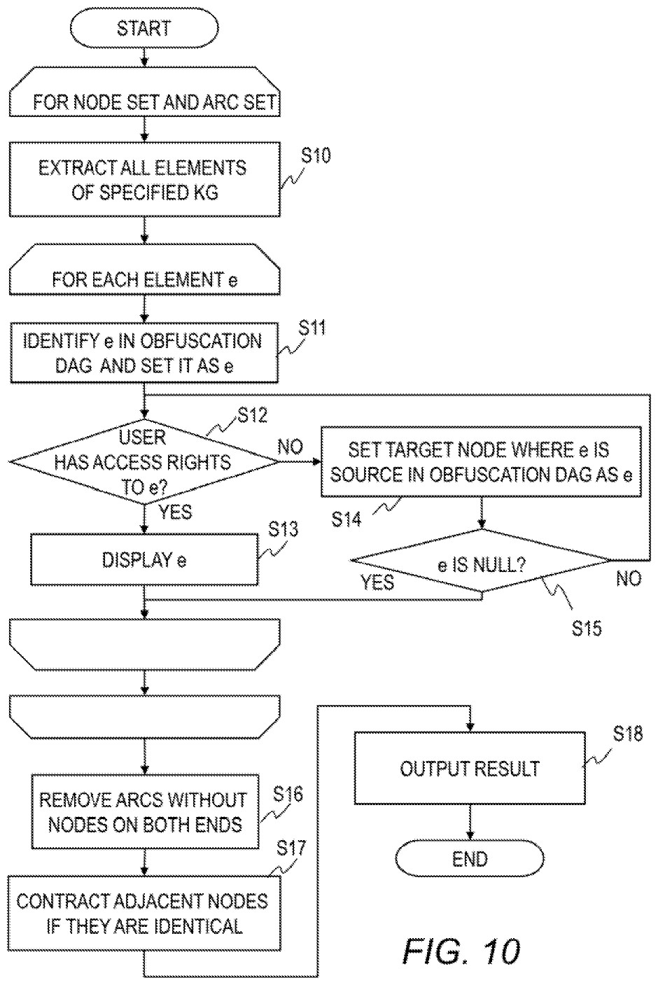

Next, a method for generating an obfuscation knowledge graph will be described. FIG. 10 shows a flowchart of an example of an algorithm for generating an obfuscation knowledge graph. The accessible information output unit 122 executes the processing shown in FIG. 10 for the user who presents the obfuscation knowledge graph and the knowledge graph to be obfuscated, which are designated via the input device 104.

The accessible information output unit 122 executes steps S10 to S15 on the node set and the arc set of the knowledge graph information 132. In step S10, the accessible information output unit 122 extracts all elements of the designated knowledge graph, that is, all nodes and all arcs, from the knowledge graph information 132.

Specifically, the accessible information output unit 122 identifies the ID of the knowledge graph designated in the graph management information 330, and extracts the node ID and arc ID associated with the ID from the graph and node relationship information 360 and the graph and arc relationship information 370. The accessible information output unit 122 extracts node and arc information of the extracted IDs from the node information 340 and the arc information 350.

The accessible information output unit 122 sequentially executes steps 511 to S15 for the extracted elements. In step S11, the accessible information output unit 122 identifies the selected element in the node obfuscation structure information 133 or the arc obfuscation structure information 134, and sets it as an element e. Specifically, the accessible information output unit 122 searches for the node hierarchy ID indicated by the node information 340 or the arc hierarchy ID indicated by the arc information 350 using the node information 420 in the node obfuscation structure or the node information 470 in the arc obfuscation structure.

Next, in step S12, the accessible information output unit 122 determines whether the designated user has access rights to the element e. Specifically, the accessible information output unit 122 refers to the personal management information 300 in the user management information 131 and acquires the ID of the designated user. Furthermore, the ID of the team to which the user belongs is acquired from the personal and team relationship information 320. The accessible information output unit 122 refers to the node access management information 500 or the arc access management information 510 in the access control information 135 to check the access rights to the node hierarchy ID or arc hierarchy ID of the element e.

If the designated user has access rights to the element e (S12: YES), the accessible information output unit 122 determines the element e as a display target in the obfuscation knowledge graph in step S13.

If the designated user does not have access rights to the element e (S12: NO), the accessible information output unit 122 sets a target node (adjacent node) whose source (start point) is the element e in the node obfuscation structure information 133 or the arc obfuscation structure information 134 as the element e in step S14. The adjacent node can be identified by referring to the arc information 430 in the node obfuscation structure or the arc information 480 in the arc obfuscation structure. The search order may be either breadth-first or depth-first.

Next, in step S15, it is determined whether the element e is null. If the element e is null, that is, if it does not exist (S15: YES), the next element in the designated knowledge graph is selected. If the element e is not null, that is, if it exists (S15: NO), the flow returns to step S12.

When steps S11 to S15 are executed for all nodes and arcs of the designated knowledge graph, a display method for all nodes and arcs is determined. The elements of the node and arc in the knowledge graph are assigned an original description or an obfuscated description, or are excluded from the display target.

In step S16, the accessible information output unit 122 deletes arcs that do not have nodes at both ends. Furthermore, in step S17, the accessible information output unit 122 contracts adjacent nodes when they are the same. In this way, a knowledge graph that is easier to see is constructed. Note that steps S16 and S17 may be omitted. Finally, in step S18, the accessible information output unit 122 outputs the created obfuscated knowledge graph to the output device 105.

Within the DAG of the obfuscation structure, there may be a plurality of obfuscation nodes for one node. The example above takes the one found first in the search order. As another example, one may be randomly selected after searching all nodes. Another example may present a plurality of found obfuscation nodes for user selection.

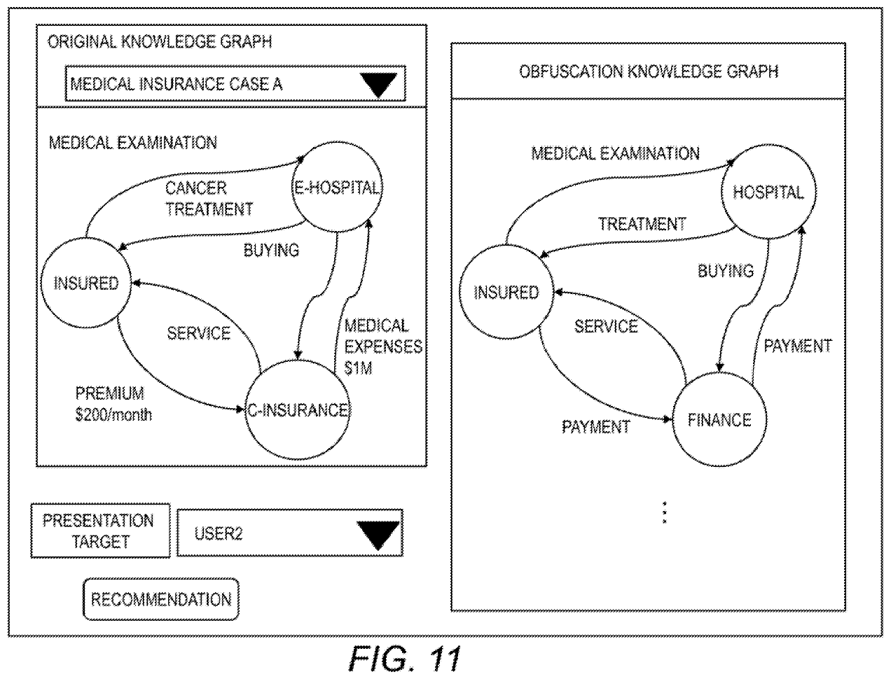

FIG. 11 shows an example of a graphical user interface (GUI) screen for knowledge graph obfuscation. The user designates the user presenting the obfuscation knowledge graph and the original knowledge graph to be obfuscated on the GUI screen. In the example of FIG. 11, the knowledge graphs of “user 2” and “medical insurance case” are designated.

When the user selects the “recommendation” button, the accessible information output unit 122 generates a knowledge graph obfuscated as described with reference to FIG. 10, and displays it on the GUI screen. In the example of FIG. 11, the obfuscated knowledge graph is displayed together with the knowledge graph from which it is obfuscated.

### Second Embodiment

An embodiment of the present embodiment presents a quantitative indicator of the sensitivity of each node in the obfuscation structure. In this way, the user creating the obfuscation knowledge graph can know how sensitive each element of the knowledge graph is. The lower the degree of sensitivity of a node (information), the higher the degree of obfuscation of the node. Differences from the first embodiment will be mainly described below.

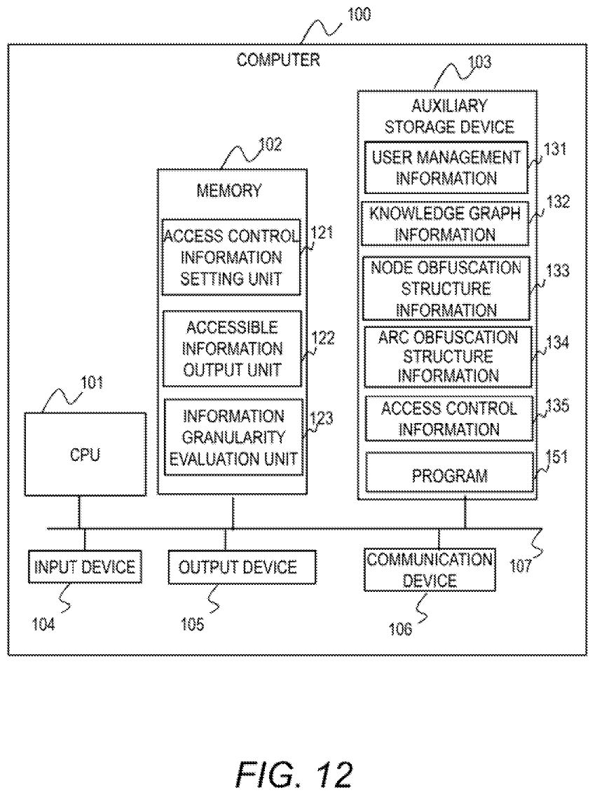

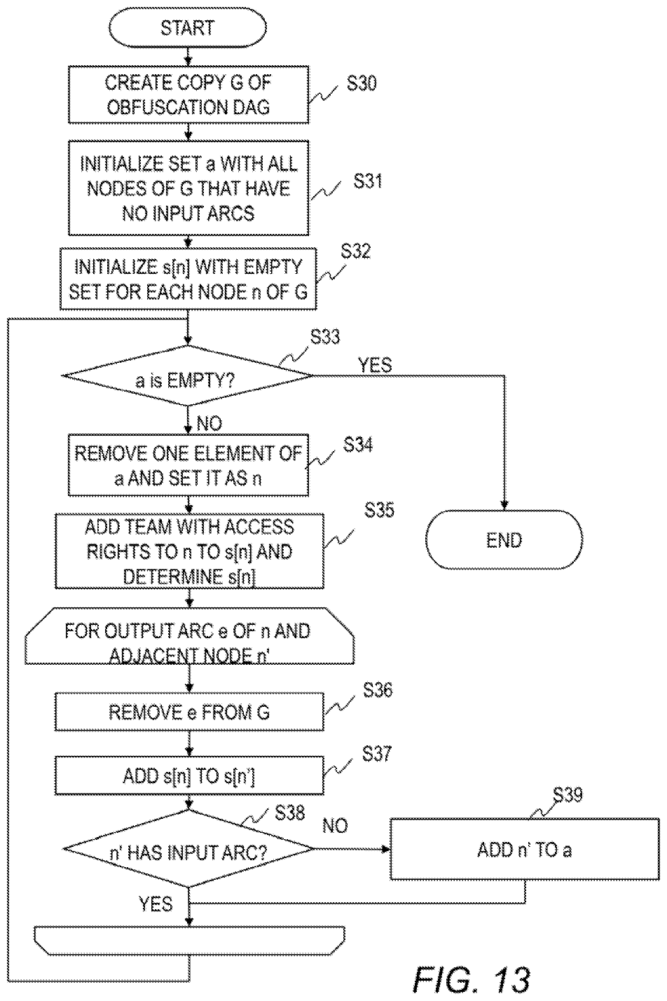

FIG. 12 shows a configuration example of a computer 100 of an embodiment of the present specification. An information granularity evaluation unit 123 is added to the configuration example shown in FIG. 1. FIG. 13 shows a flowchart of an example of an information granularity evaluation algorithm executed by the information granularity evaluation unit 123. The information granularity evaluation unit 123 may perform the processing shown in FIG. 13 on the node obfuscation structure information 133 or the arc obfuscation structure information 134.

In step S30, the information granularity evaluation unit 123 creates a copy graph G of an obfuscation structure (obfuscation DAG). Next, in step S31, the information granularity evaluation unit 123 initializes the set a with all the nodes of the copy graph G that do not have an input arc. Further, in step S32, the information granularity evaluation unit 123 initializes s[n] for each node n of the copy graph G with an empty set.

Next, in step S33, the information granularity evaluation unit 123 determines whether the set a is empty. If the set a is empty (S33: YES), this flow ends. When the set a is not empty (S33: NO), in step S34, the information granularity evaluation unit 123 removes one element from the set a and sets it as a node n. Furthermore, the information granularity evaluation unit 123 adds a team that has access rights to the node n to the set s[n] and determines the set s[n].

Next, the information granularity evaluation unit 123 executes the following processing for each combination of the output arc e and the adjacent node n′ of the node n. In step S36, the information granularity evaluation unit 123 deletes the arc e from the copy graph G. In step S37, the information granularity evaluation unit 123 adds the set s[n] to the set s[n′].

In step S38, the information granularity evaluation unit 123 determines whether the adjacent node n′ has an input arc. If the adjacent node n′ does not have an input arc (S38: NO), in step S39, the information granularity evaluation unit 123 adds the adjacent node n′ to the set a, and proceeds to the next loop. If the adjacent node n′ has an input arc (S38: YES), the information granularity evaluation unit 123 proceeds to the next loop without executing step S39. When the entire loop of steps S36 to S39 ends, the flow returns to step S33.

In the processing described with reference to FIG. 13, the set s[n] is a set of teams that have access rights to either the target node n or its descendant nodes, and the number of teams is the number of unique teams that have that have access rights to these nodes. The set of teams consists of different teams, and the same teams do not overlap. The number of unique teams is the number of different teams.

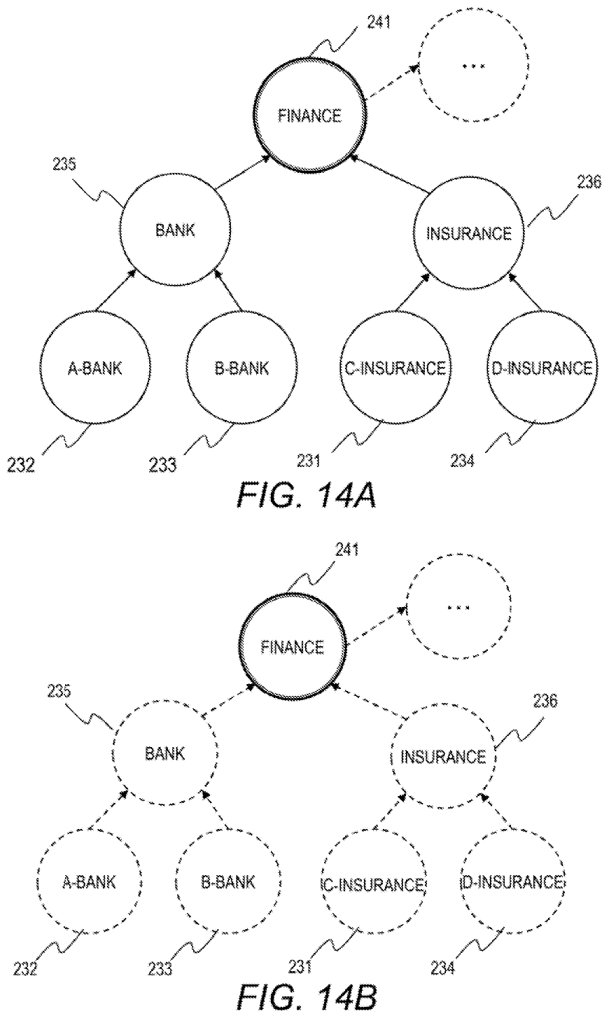

FIG. 14A is a diagram for explaining an example of the set s[n]. The node of the knowledge graph that is the source of the obfuscation is the C-insurance node 231, and the node obtained by obfuscating it is the finance node 241. The set s[n] of the finance node 241 is a set of teams that have access rights to the finance node 241 and any one of the nodes 231 to 236 that are descendant nodes of the finance node 241.

The number of teams that make up the set s[n] is a quantitative indicator of the sensitivity of the node n. The larger the number of teams, the smaller the degree of sensitivity of the node, that is, the larger the degree of obfuscation. The information granularity evaluation unit 123 may present the calculated degree of sensitivity of the node (degree of obfuscation) to the system user who has created the obfuscation knowledge graph on the output device 105.

The information granularity evaluation unit 123 may automatically set access rights based on the relationship between the degree of sensitivity (degree of obfuscation) and a threshold. For example, the information granularity evaluation unit 123 receives a designation of a user for whom access rights are to be set from the system user. If the degree of sensitivity calculated based on the number of access right holders to each node as described above is lower than the threshold (the degree of obfuscation is high), the designated user's access rights to the node is set in the access control information 135. The threshold may be designated by the system user or set by the system design.

In another example, a quantitative indicator of the sensitivity of the node n may be the number of unique teams that have access rights to the node n. By omitting the propagation of the set s[n] in the processing of FIG. 13, the number of unique teams having access rights can be counted by focusing only on each node.

FIG. 14B is a diagram for explaining the number of unique teams that have access rights to a target node. As in FIG. 14A, the node of the knowledge graph that is the source of the obfuscation is the C-insurance node 231, and the node that obfuscates it is the finance node 241. The number of teams that have access rights to the finance node 241 is a quantitative indicator of the sensitivity of the finance node 241.

In another example, a quantitative indicator of the sensitivity of the node n may be the number of unique teams that have access rights to nodes on the path between the node and the original obfuscation source node. The original obfuscation source node is the node of the knowledge graph before the obfuscation. In the processing of FIG. 13, the number of unique teams can be counted by changing the initialization of the set a to target leaves instead of all leaves.

FIG. 14C is a diagram for explaining the number of unique teams that have access rights to nodes on the path between the target node and the original obfuscation source node. As in FIG. 14A, the node of the knowledge graph that is the source of the obfuscation is the C-insurance node 231, and the node that obfuscates it is the finance node 241. Only the insurance node 236 exists on the path between the C-insurance node 231 and the finance node 241. The set of teams that have access rights to either the C-insurance node 231, the insurance node 236, or the finance node 241 is the set s[n]. The number of teams in this set s[n] is a quantitative indicator of the sensitivity of the finance node 241.

In another example, the quantitative indicator of sensitivity may be the total number of teams (the same team can be counted a plurality of times) instead of the number of unique teams. In the processing in FIG. 13, the total number of teams can be calculated by replacing the set with a list. Moreover, the number of users may be used instead of the number of teams. A percentage of the total number of nodes may be used instead of the number of teams or users. Each of the above quantitative indicators allows the user creating the obfuscation knowledge graph to know how sensitive each element of the knowledge graph is. Note that the quantitative indicator of sensitivity may be calculated only for some nodes of the obfuscation DAG.

As described above, by quantifying the degree of sensitivity of a node based on the number of access right holders to the nodes in the obfuscation DAG, it is possible to appropriately represent the degree of sensitivity of each node. The access right holders may be represented by the number of teams as described above, or may be represented by the number of users forming the teams.

### Third Embodiment

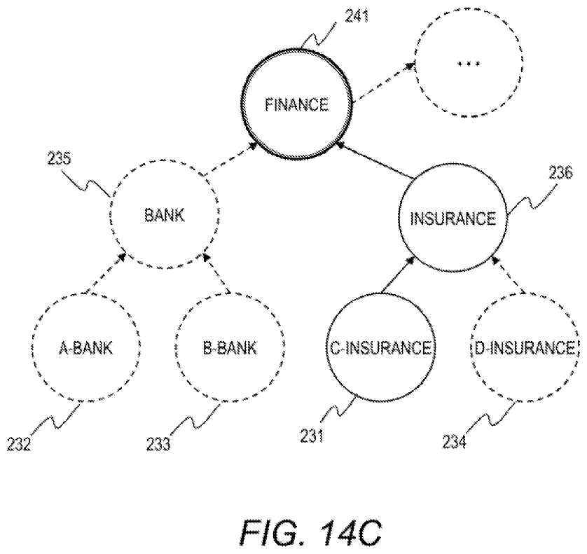

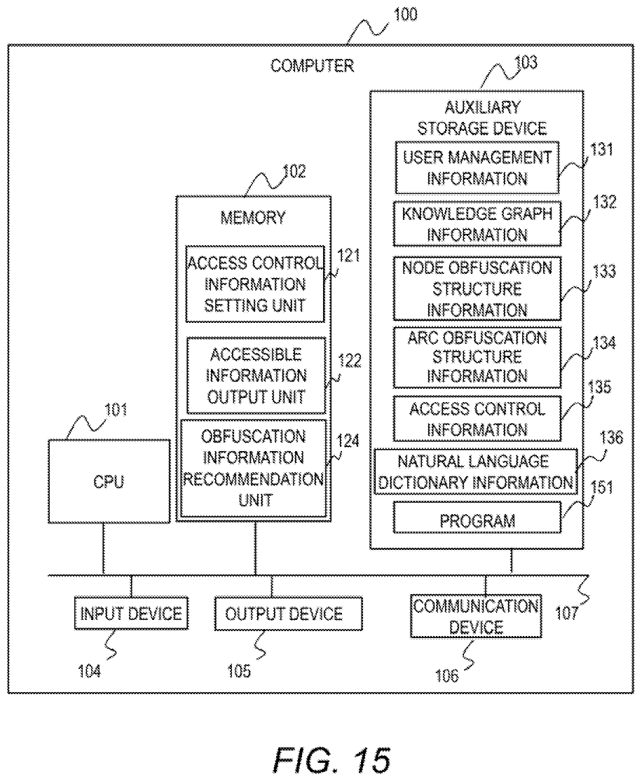

An embodiment of the present specification makes predictions of obfuscation destinations and recommends them to the user. In this way, the user can efficiently set the obfuscation information for each element in the obfuscation structure. Differences from the first embodiment will be mainly described below. FIG. 15 shows a configuration example of the computer 100 of an embodiment of the present specification. An obfuscation information recommendation unit 124 is added to the configuration example shown in FIG. 1. FIG. 16 shows a flowchart of an example of an obfuscation DAG arc recommendation algorithm executed by the obfuscation information recommendation unit 124. The obfuscation information recommendation unit 124 can perform the processing for the obfuscation DAG (obfuscation structure) of the node obfuscation structure information 133 or the arc obfuscation structure information 134.

In step S50, the obfuscation information recommendation unit 124 acquires the natural language feature amounts of the nodes of the obfuscation DAG using a natural language processing model such as BERT or Word2vec.

Next, in step S51, the obfuscation information recommendation unit 124 learns a link prediction model using a machine learning model such as a graph neural network (GNN). In learning, the graph structure of the obfuscation DAG and the natural language feature amounts obtained in step S50 are used. The link prediction model receives the graph structure of the obfuscation DAG and the natural language feature amounts of the nodes of the obfuscation DAG as inputs, and calculates the probability (score) of the presence of a link between nodes.

Next, in step S52, the obfuscation information recommendation unit 124 uses the learned link prediction model to calculate the score of the link between each node in the obfuscation DAG and other nodes. Furthermore, in step S53, the obfuscation information recommendation unit 124 outputs a predetermined number of links (node pairs) in descending order of scores. The condition that the score of the link to be output is higher than a threshold may be employed. The user sets links that are determined to be appropriate from the presented links to the obfuscation DAG.

The obfuscation information recommendation unit 124 may accept designation of one or more nodes for which link prediction is to be performed in the obfuscation DAG. The obfuscation information recommendation unit 124 may add a new node to the obfuscation DAG after learning the link prediction model, receive the designation of the node, and predict the destination of the obfuscation. The obfuscation information recommendation unit 124 outputs a link with a high score for the designated node. The obfuscation information recommendation unit 124 may automatically set a link whose score exceeds the threshold in the obfuscation DAG.

### Fourth Embodiment

An embodiment of the present specification predicts access rights to each node of the obfuscation DAG and makes recommendations to the user. In this way, it is possible to efficiently set access rights to nodes.

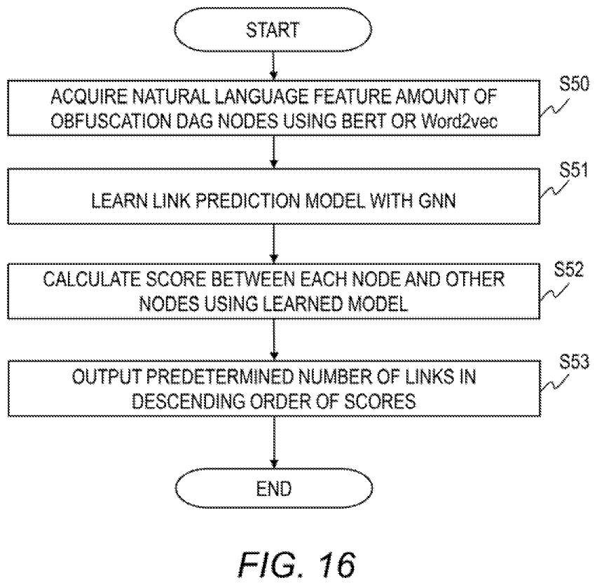

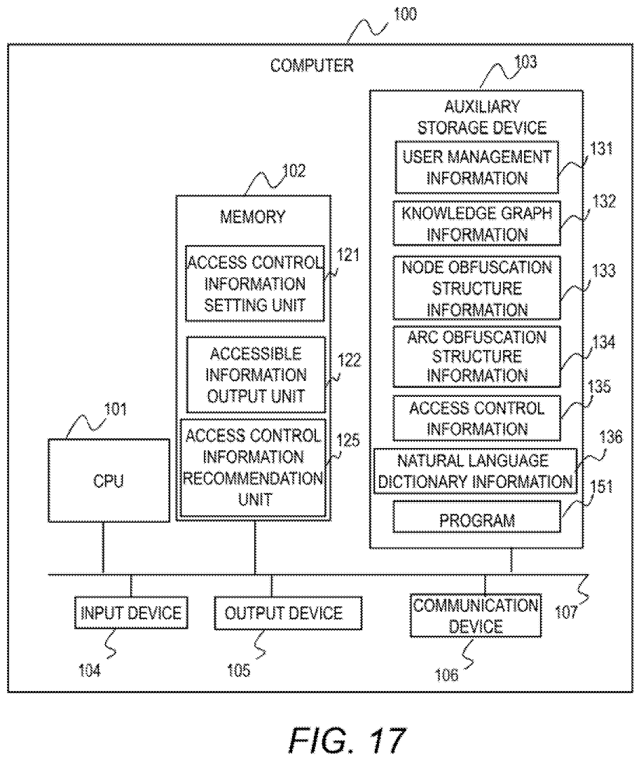

FIG. 17 shows a configuration example of a computer 100 according to an embodiment of the present specification. An access control information recommendation unit 125 is added to the configuration example shown in FIG. 1. FIG. 18 shows a flowchart of an example of an obfuscation DAG node access right recommendation algorithm executed by the access control information recommendation unit 125. The access control information recommendation unit 125 can perform this processing for the obfuscation DAG (obfuscation structure) of the node obfuscation structure information 133 or the arc obfuscation structure information 134.

In step S70, the access control information recommendation unit 125 acquires the natural language feature amounts of the nodes of the obfuscation DAG using a natural language processing model such as BERT or Word2vec.

Next, in step S71, the access control information recommendation unit 125 uses a machine learning model such as GNN to perform semi-supervised learning of an access right prediction model for binary classification of team access rights. In the semi-supervised learning, the graph structure of the obfuscation DAG, the natural language feature amounts obtained in step S70, and the access control information 135 indicating the team to which the access rights to each node is given are used. Co-occurrence analysis based on association rules may be used instead of GNN.

In step S72, the access control information recommendation unit 125 predicts the score of the access rights to the target node using the learned access right prediction model. The access right prediction model uses the graph structure of the obfuscation DAG and the natural language feature amounts of the nodes of the obfuscation DAG to calculate the probability (score) of the presence of each team's access rights to each node.

Furthermore, in step S73, the access control information recommendation unit 125 selects a predetermined number of pairs of nodes and teams from the pairs with high scores among the pairs of nodes and teams that have not been used for teaching, that is, pairs other than the pairs of nodes and teams to which access rights have already been given. The condition that the score of the output pair is higher than a threshold may be employed. The user sets access rights for the pairs that are determined to be appropriate from the presented pairs.

The access control information recommendation unit 125 may accept designation of a team for which access right prediction is to be performed. The access control information recommendation unit 125 presents the user with a predetermined number of nodes in descending order of the access right scores for the designated team. In another example, the access control information recommendation unit 125 may receive designation of a node for which access right prediction is to be performed. The access control information recommendation unit 125 presents the user with a predetermined number of teams in descending order of scores of the access rights to the designated node. The access control information recommendation unit 125 may automatically set the access rights for pairs whose scores exceed a threshold.

The access control information recommendation unit 125 predicts the team's access rights to the obfuscated knowledge graph in addition to or instead of the team's access rights to each node of the obfuscation DAG and makes recommendations to users. For example, the access control information recommendation unit 125 utilizes the obfuscation structure to generate a plurality of obfuscation knowledge graphs, displays several candidates with a high probability that the designated team has access rights, and allows the user to select a team.

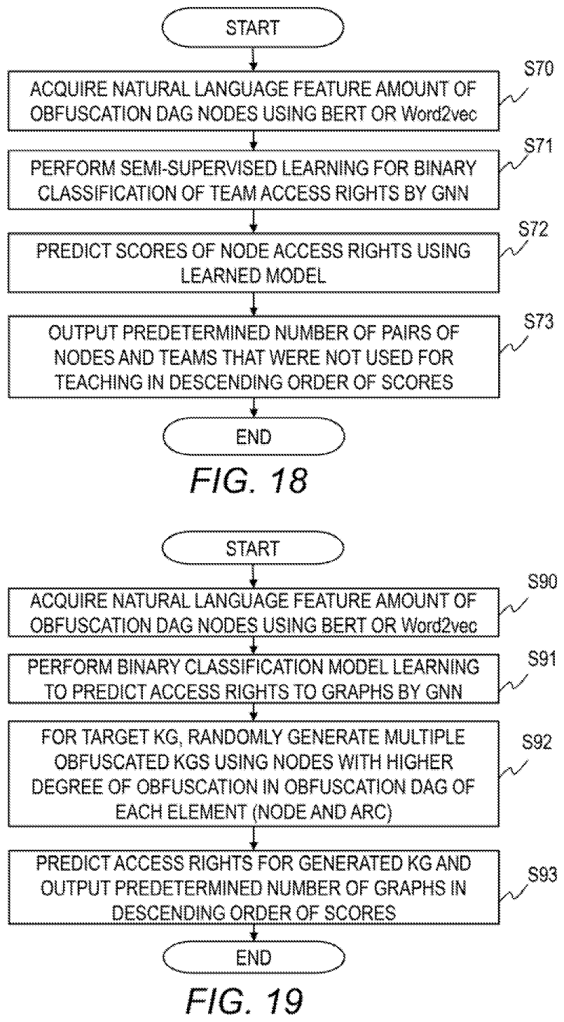

FIG. 19 shows a flowchart of an example of an automatic obfuscated knowledge graph generation and access rights recommendation algorithm. In this way, it is possible to efficiently set access rights.

In step S90, the access control information recommendation unit 125 acquires the natural language feature amounts of the nodes of the obfuscation DAG of nodes and arcs using a natural language processing model such as BERT or Word2vec.

In step S91, the access control information recommendation unit 125 uses a machine learning model such as GNN to learn a binary classification model for predicting access rights to the knowledge graph. In learning, the natural language feature amounts obtained in step S90 and the set of obfuscated knowledge graphs accessed by each team are used.

The learned access right prediction model predicts the probability (score) of the team's access rights to the knowledge graph from the graph structure of the obfuscated knowledge graph, the natural language feature amounts of the nodes and arcs, and the team identifier.

In step S92, the access control information recommendation unit 125 randomly generates a plurality of obfuscated knowledge graphs using nodes whose degrees of obfuscation are higher than each element (node or arc) in the obfuscation DAG of the nodes or arcs.

In step S93, the access control information recommendation unit 125 predicts access rights to the generated knowledge graphs using a learned access right prediction model, and outputs a predetermined number of obfuscation knowledge graphs in descending order of scores. The condition that the score of the output graph is higher than the threshold may be employed. The user sets the team's access rights to the graphs that are determined to be appropriate from the presented graphs. The access control information recommendation unit 125 may automatically set access rights to knowledge graphs whose scores exceed a threshold.

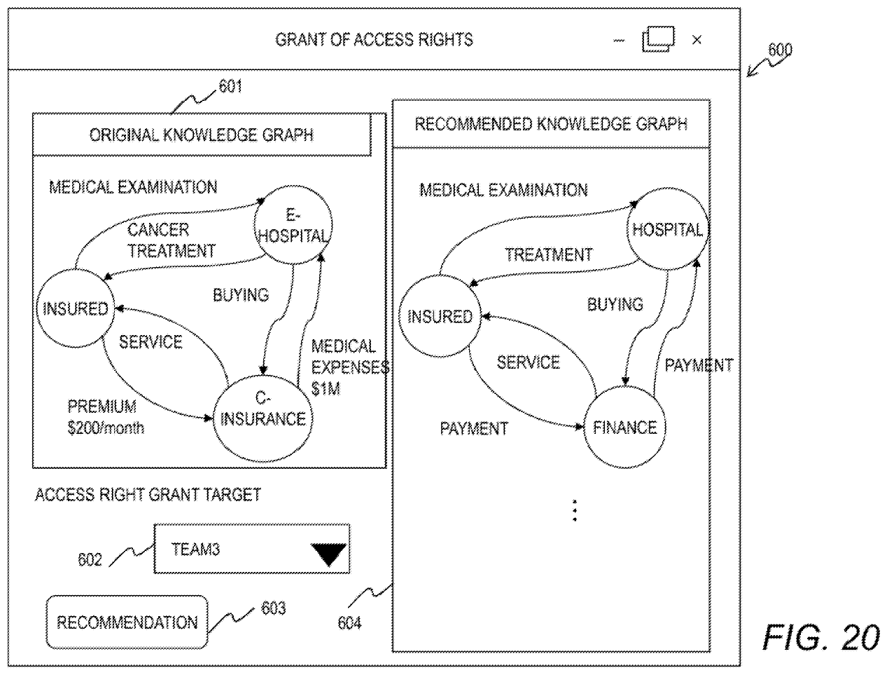

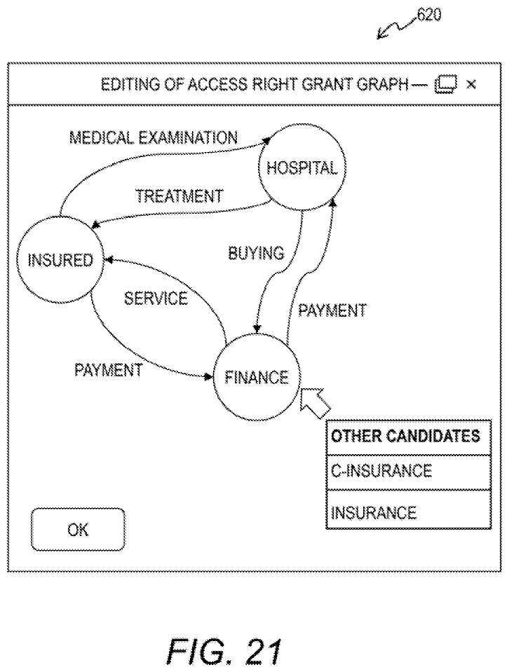

FIGS. 20 and 21 show examples of GUI screens for prediction of access rights to the knowledge graph described with reference to FIG. 19. On a GUI screen 600 shown in FIG. 20, the user designates a knowledge graph that is the source of the obfuscation knowledge graph for which access rights are predicted, and a team. Specifically, the original knowledge graph is designated in section 601, and the team is designated in section 602. When a user recommendation button 603 is selected, the processing described with reference to FIG. 19 is executed.

The GUI screen 600 displays several obfuscation knowledge graphs with high access right prediction scores in section 604. The user selects one or more knowledge graphs from the displayed obfuscation knowledge graphs.

FIG. 21 shows an example of a screen 620 showing one knowledge graph selected on the GUI screen 600. The screen 620 allows the user to edit the selected obfuscated knowledge graph. The access control information recommendation unit 125 accepts adjustment of the obfuscation knowledge graph by the user.

For example, the user can change one node or arc to another node or arc. In the example of FIG. 21, a C-insurance node and an insurance node are presented as candidates to replace the finance node. These nodes are the nodes on one obfuscation path. In this example, the finance node has the highest degree of obfuscation and the C-insurance node has the lowest degree of obfuscation. When an OK button is selected, the access rights of the designated team to the displayed nodes and arcs are set in the access control information 135.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The program code to realize the functions described in the embodiments can be implemented in a wide range of programs or scripting languages, such as assembler, C/C++, perl, Shell, PHP, Python, Java, etc.

Furthermore, by distributing the program code of software that implements the functions of the example through a network, it can be stored in a computer's hard disk, memory, or other storage media such as a CD-RW, CD-R, etc., and a processor equipped with the computer may rea and execute the program code in the storage means or storage media.

The drawings show control lines and information lines as considered necessary for explanations but do not show all control lines or information lines in the products. It can be considered that almost of all components are actually interconnected.

What is claimed is:

1. A knowledge graph access control system comprising:
an arithmetic device; and
a storage device,
the storage device storing:
obfuscation structure information that defines an inclusion relationship between elements with different degrees of obfuscation in a knowledge graph; and
access control information for managing user's access rights to each element included in the obfuscation structure information,
the arithmetic device being configured to:
acquire an obfuscation target knowledge graph;
generate an obfuscation knowledge graph by obfuscating the target knowledge graph for a first user with reference to the obfuscation structure information and the access control information; and
in the obfuscation of the target knowledge graph, convert an original element included in the target knowledge graph to an obfuscation element to which the first user has access rights in the access control information, and which includes the original element in the obfuscation structure information.

2. The knowledge graph access control system according to claim 1, wherein
the arithmetic device determines a degree of obfuscation of a first element included in the obfuscation structure information based on the number of access right holders to the first element, and
information indicating the determined degree of obfuscation is presented on an output device.

3. The knowledge graph access control system according to claim 2, wherein
the arithmetic device determines the degree of obfuscation of the first element further based on the number of access right holders to elements included in the first element.

4. The knowledge graph access control system according to claim 2, wherein
the arithmetic device sets a second user's access rights to the first element if the determined degree of obfuscation exceeds a threshold.

5. The knowledge graph access control system according to claim 1, wherein
the obfuscation structure information indicates the inclusion relationship using a directed acyclic graph,
the arithmetic device predicts a new obfuscation destination of a second element in the directed acyclic graph and presents a result of the prediction on an output device, and
the prediction of the obfuscation destination is based on a structure of the directed acyclic graph and amount of nodes of natural language features of the directed acyclic graph.

6. The knowledge graph access control system according to claim 1, wherein
the arithmetic device predicts third user's access rights to a third element in the obfuscation structure information based on a relationship between the element of the obfuscation structure information indicated by the access control information and an access right holder, and presents a result of the prediction on an output device.

7. The knowledge graph access control system according to claim 1, wherein
the arithmetic device is configured to:
generate candidate obfuscation knowledge graphs for a first knowledge graph based on the obfuscation structure information; and
use a prediction model prepared in advance to predict fourth user's access rights to the candidate obfuscation knowledge graphs and present a result of the prediction on an output device.

8. The knowledge graph access control system according to claim 7, wherein
the arithmetic device is configured to:
present candidate obfuscation knowledge graphs whose prediction satisfies a predetermined condition on the output device; and
accept user adjustments to the presented candidate obfuscated knowledge graphs.

9. A knowledge graph access control method executed by a system,
the system storing:
obfuscation structure information that defines an inclusion relationship between elements with different degrees of obfuscation in a knowledge graph; and
access control information for managing user's access rights to each element included in the obfuscation structure information, and
the method causing the system to execute:
acquiring an obfuscation target knowledge graph;
generating an obfuscation knowledge graph by obfuscating the target knowledge graph for a first user with reference to the obfuscation structure information and the access control information; and
in the obfuscation of the target knowledge graph, converting an original element included in the target knowledge graph to an obfuscation element to which the first user has access rights in the access control information, and which includes the original element in the obfuscation structure information.
